(19) United States
(12) Patent Application Publication
(10) Pub. No.: US 2025/0118770 A1
(43) Pub. Date: Apr. 10, 2025

(54) SYSTEM AND METHOD FOR A BATTERY MANUFACTURING PROCESS HAVING INDUCTION HEATING AND CONVECTION COOLING

(71) Applicant: Ford Global Technologies, LLC, Dearborn, MI (US)

(72) Inventors: Benjamin Jason Emley, Canton, MI (US); Martin Andrew Frania, Canton, MI (US)

(21) Appl. No.: 18/482,590

(22) Filed: Oct. 6, 2023

(51) Int. Cl. H01M 6/50

(52) U.S. Cl. CPC H01M 6/5038

(57) ABSTRACT

A system for a battery manufacturing process includes a housing defining a chamber adapted to receive an electrode substrate, a vacuum system fluidly coupled to the housing and operable to remove particles in the chamber via suction, and an induction dry-cool system including one or more coils provided in the chamber. The one or more coils are operable to heat the electrode substrate via induction during a dry operation and to reduce temperature of the electrode substrate during a cooling operation. The system further includes a control system configured to control the vacuum system and the induction dry-cool system during the dry operation and the cooling operation.

### TECHNICAL FIELD

The present disclosure relates to a system and/or method for performing a battery manufacturing process, and more particularly, a system and/or method for a drying stage of the battery manufacturing process.

### BACKGROUND

A battery manufacturing process can generally include an electrode preparation process, a cell assembly process, and a battery electrochemistry activation process. The electrode preparation process can include a coating stage, also referred to as a wet film process/stage, during which electrodes are coated on metallic foil using a liquid mixture (i.e., a liquid solution) to form anode and cathode. Prior to the cell assembly process, the liquid solution is removed at a primary drying stage and an auxiliary drying stage. At the primary drying operation, most of the liquid solution from the electrode is removed. The electrode is then stacked and cut into defined cell dimensions. At the auxiliary drying stage, the stacked electrode (i.e., an electrode substrate) is heated to remove any residual moisture. From the auxiliary drying stage of the electrode preparation process, the electrode is provided to the cell assembly process.

### SUMMARY

In one form, the present disclosure is directed to a system for a battery manufacturing process. The system includes a housing defining a chamber adapted to receive an electrode substrate, a vacuum system fluidly coupled to the housing and operable to remove particles in the chamber via suction, and an induction dry-cool system including one or more coils provided in the chamber. The one or more coils are operable to heat the electrode substrate via induction during a dry operation and to reduce temperature of the electrode substrate during a cooling operation. The system further includes a control system configured to control the vacuum system and the induction dry-cool system during the dry operation and the cooling operation.

In one form, the present disclosure is directed to a system for a battery manufacturing process. The system includes a housing defining a chamber adapted to receive an electrode substrate, a vacuum system fluidly coupled to the housing and operable to remove particles in the chamber via suction, and an induction dry-cool system including one or more coils provided in the chamber. The one or more coils are operable to heat the electrode substrate via induction during a dry operation. The system further includes a control system configured to control the vacuum system and the induction dry-cool system during the dry operation. For the dry operation, the control system is configured to control power to the one or more coils until a desired thermal profile is obtained for the electrode substrate, and activate the vacuum system to induce suction in the chamber to remove air from the chamber.

In one form, the present disclosure is directed to a system for a battery manufacturing process. The system includes a vacuum system, an induction dry-cool system, and a control system. The vacuum system is fluidly coupled to a housing defining a chamber adapted to receive an electrode substrate, and operable to remove particles in the chamber via suction. The induction dry-cool system includes one or more coils provided in the chamber. The one or more coils define an internal fluid path and operable to heat the electrode substrate via induction during a dry operation and to reduce temperature of the electrode substrate during a subsequent cooling operation. The control system is configured to, during the dry operation, control power to the one or more coils until a desired thermal profile is obtained for the electrode substrate, and activate the vacuum system to induce suction in the chamber to remove air from the chamber, and during the cooling operation, stop power to the one or more coils, and circulate coolant through the internal fluid path.

### BRIEF DESCRIPTION OF THE DRAWINGS

FIG. 1 is a process flow diagram of a battery manufacturing process in accordance with the present disclosure;

FIG. 2 illustrates a system for performing an auxiliary drying operation of an electrode substrate in accordance with the present disclosure;

FIG. 3 illustrates an example coil of an induction dry-cool system in accordance with the present disclosure;

FIG. 4 illustrates an internal fluid path of a coil in accordance with the present disclosure; and

FIG. 5 is a process flow diagram of a dry operation and a cool operation in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Advancements in battery manufacturing have provided enhancements in tooling and automation, which can significantly benefit high demand and high manufacturing rate industries, such as, but not limited to, electric vehicles.

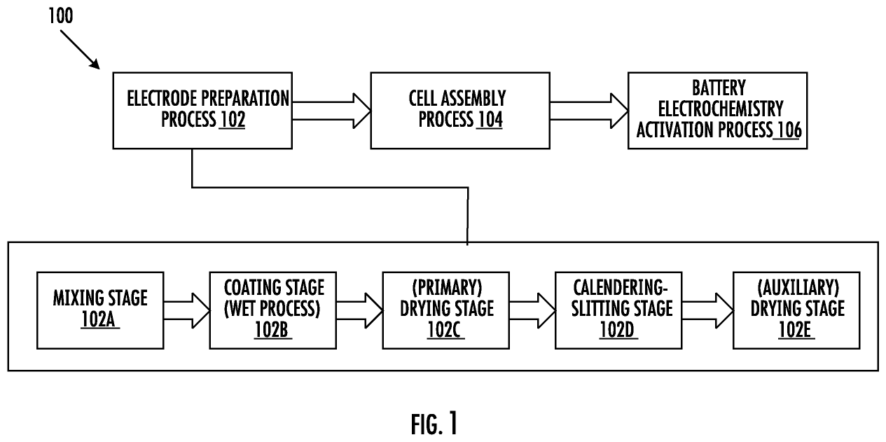

Referring to FIG. 1, an example battery manufacturing process 100 includes an electrode preparation process 102, a cell assembly process 104, and a battery electrochemistry activation process 106. In a non-limiting example, the electrode preparation process 102 includes: a mixing stage 102A to mix raw materials, such as active metals, solvents, and other chemical, to form an anode and a cathode; a coating stage 102B to form the anode and the cathode by applying respective liquid mixture (i.e., a liquid solution) to the electrode, which may be sheet of material (e.g., aluminum); a primary drying stage 102C to remove moisture and dry most of the liquid solution; a calendaring-slitting stage 102D to roll the electrode and cut the electrode into predefined dimensions forming a stack of electrodes (i.e., one or more electrode substrates); and an auxiliary drying stage 102E to remove any remaining moisture from the electrode substrates.

If not dried, the liquid solution can adversely affect the battery, and therefore, two different drying methods at different stages of the battery manufacturing process 100 are implemented. The primary drying stage 102C is adapted to remove majority of the moisture and may employ large/long drying lines to remove the liquid solution from the electrode. In a non-limiting example, the drying lines for the primary drying stage 102C may use an infrared heat source or a convection heat source such as heated gas.

The auxiliary drying stage 102E removes residual liquid solution, such as solution inside of a porous electrode due to capillary forces, and is commonly done in a clean room. In a conventional auxiliary drying stage, the electrode substrate is dried in a vacuum oven in a batch-style process and includes three steps: heating to dry the electrode substrate; vacuum soaking to suction and remove particles that may be a byproduct of the heating step; and cooling to reduce the temperature of the electrode substrate. Vacuum drying can use comparatively large amounts of space and energy to operate, and many vacuum ovens are needed for a giga-W rated battery factory.

The battery manufacturing process 100 is just one example process, and the present disclosure may be implemented in other suitable processes. In a non-limiting example, the calendaring-slitting stage 102D may be split into multiple stage, such that the auxiliary drying stage 102E is performed after the electrode is rolled, but before the electrode is cut into sheets. Accordingly, the auxiliary drying stage 102E, as described herein, may be configured to dry electrode substrates having different forms, such as, but not limited to electrode roll, electrode sheets.

In one form, the present disclosure is directed to a battery manufacturing system having an auxiliary drying stage employing a vacuum-induction heating system for heating and cooling the electrode substrate. As described herein, the vacuum-induction heating system uses induction to heat the electrode substrate to remove remaining liquid solution on the electrode substrate and actively cools the electrode substrate employing a cooling convection feature of the vacuum-induction heating system.

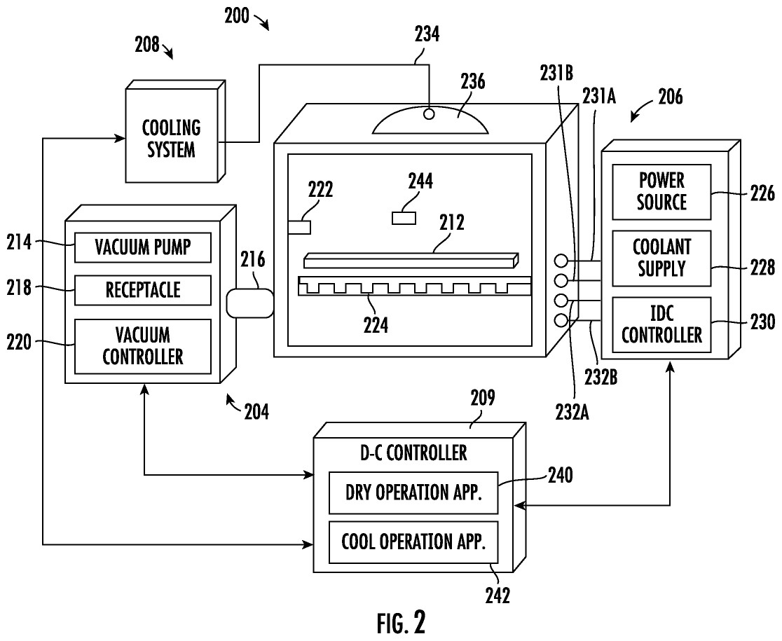

Referring to FIG. 2, an example of the vacuum-induction heating system 200 includes a housing 202, a vacuum system 204, an induction dry-cool (IDC) system 206, a cooling system 208, and a dry-cool (D-C) controller 209.

The housing 202 defines a chamber 210 for receiving an electrode substrate 212. In one form, the housing is thermally insulated to prevent transfer of thermal energy between the chamber 210 and an external environment of the housing 202.

The vacuum system 204 is operable to remove particles in the chamber 210 via suction, and, in one form, includes a vacuum pump 214, a conduit 216, and a receptacle 218. The conduit 216 extends into the chamber 210 and is connected to the receptacle 218. In operation, the vacuum pump 214 creates low pressure in the chamber 210 or, stated differently, generates a suctional force drawing fluid (e.g., air) and particles from the chamber 219 through the conduit 216 and to the receptacle 218. The receptacle 218 may further be connected to a filtration device to process the air and/or particles drawn from the chamber 210.

The vacuum system 204 may include other components, such as, but not limited to, a vacuum controller 220 and a pressure sensor 222 arranged in the chamber 210 for monitoring pressure within the chamber 210. In one form, the vacuum controller 220 is configured to activate and control the vacuum pump 214 based on data from the pressure sensor 222 and identified parameters (e.g., parameters may include a desired pressure, duration of pressure soak).

The IDC system 206, which may also be referred to as an induction heat-cool system, is operable to heat the electrode substrate 212 using induction. In one form, the IDC system 206 includes one or more coils 224 (“coil 224”, hereinafter), a power source 226, a coolant supply 228 to cool the coil 224, and an IDC controller 230 configured to control the induction heating process. In one form, the power source 226 is electrically coupled to the coil 224 via electrical connectors 231A, 231B, and is operable to provide power to the coil 224. In a non-limiting example, the power source 226 is connected to a main power supply and includes power converter (e.g., a buck-converter or step-converter) and other electronics to adjust the power to provide high frequency alternative current (AC).

The coil 224 is adapted to be in a non-contact proximity to the electrode substrate 212 to heat the electrode substrate 212 using induction. More particularly, the coil 224, as an inductor, generates a magnetic field when power is applied. The magnetic field induces an electric current in the electrode substrate 212 that flows on surfaces of the substrate 212. The resistivity or resistance of the electrode substrate 212 causes heat to build-up as the electric current encounters the resistance. As the electrode substrate 212 heats, the natural resistance generally increases forming more heat to increase the temperature of the electrode substrate 212.

Induction heating is a non-contact method for heating the electrode substrate 212 without having to heat the entire chamber 210. That is, induction heating heats the electrode substate 212 directly and increases the temperature of the electrode substrate 212 in a much shorter period of time than other heating methods, such as infrared. In one form, the coil 224 is provided as close to the electrode substrate 212 as possible without contacting the electrode substrate 212.

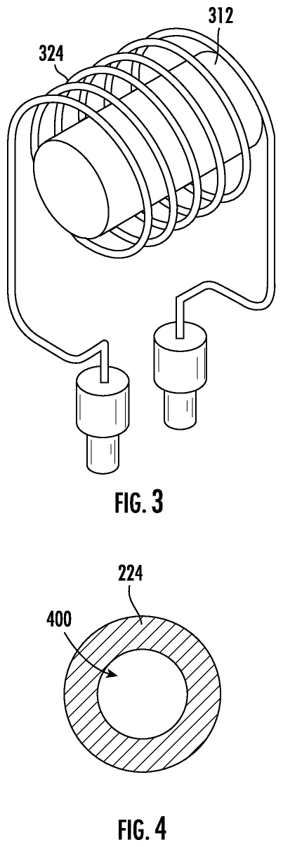

In FIG. 2, the coil 224 is provided a planar shaped coil arranged parallel with the substrate 212. However, the coil 224 may be configured in various other ways. In a non-limiting example, FIG. 3 illustrates another example coil, and specifically a coil 324 that wraps around an electrode.

Physical characteristics of the coil 224, such as the material, shape, and size of the coil 224, are designed to provide a strong magnetic field and control a thermal profile of the electrode substrate 212 to provide a homogeneous temperature during the heating process, which further provides a uniform thermal profile of the electrode substrate 212. Selection of the physical characteristics may be influenced by various factors including, but not limited to, composition of the electrode substrate 212, material of a magazine (not shown) holding the electrode substrate 212, and/or structure of the electrode substrate 112.

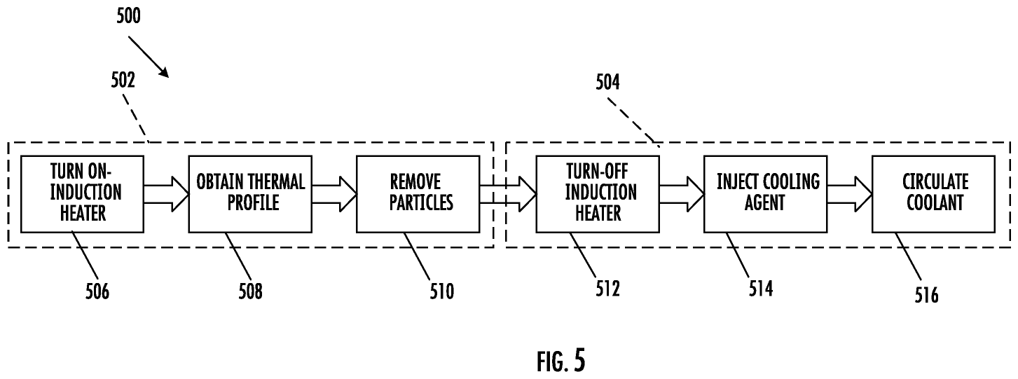

With continuous reference to FIG. 2 and reference to FIG. 4, the coolant supply 228 is operable to circulant coolant through the coil 224. Specifically, in one form, the coil 224 defines an internal fluid path 400 that extends from one end of the coil 224 to another end of the coil 224. In non-limiting example, the coolant supply 228 is connected to the coil 224 and specifically, the internal fluid path 400 via connectors 232A and 232B. Coolant is circulated in the coil 224 to cool the coil 224 during the heating process, and with a chilled fluid circulating therein, the coil 224 may provide a strong magnetic field that induces inductive heat within the electrode substrate 212. In addition, the coils 224 themselves are cooled to inhibit or reduce any resistive heat from generating on tooling parts associated with the coil 224.

The coolant supply 228 may further be operated during a cooling operation of the electrode substrate 212. That is, with power to the coil 224 turned off, coolant circulates through the coil 224 to absorb heat from the electrode substrate 212, thereby reducing the temperature of the electrode substrate 212. Accordingly, the coil 224 may be used as a heat exchanger to transfer heat from electrode substrate 212 to the coolant flowing in the coil 224.

In a non-limiting example, among other components, the coolant supply 228 may include a reservoir for the coolant, a pump for circulating the coolant through the coil 224, and a condenser for reducing the temperature of coolant returning from the coil 224.

The IDC controller 230 is configured to control the IDC system 206 and specifically, the induction heating process by, for example, operating the power source 226 to control power to the coil 224, and operating the coolant supply 228 to circulate fluid through the coil. In one form, the IDC controller 230 receive data related to temperature of the electrode substrate 212 and may adjust power to the coil 224 (i.e., increase or decrease power to the coil 224) to obtain a desired thermal profile of the electrode substrate 212.

In some applications, the cooling system 208 is configured to inject a cooling agent (e.g., nitrogen gas) into the chamber 210 of the housing 202 to assist in cooling the electrode substrate 212. In one form, the cooling system 208 includes a conduit 234 and a spout 236 to fluidly couple to the housing 202. The spout 236 is connected to a vent of the chamber 210 to inject the cooling agent into the chamber 210. It should be readily understood that other cooling agents may be used for cooling the electrode substrate 212, and the present disclosure should not be limited to nitrogen.

The D-C controller 209 is configured to control the vacuum system 204, the IDC system 206, and the cooling system 208 to heat the electrode substrate 212 during the dry operation and to reduce the temperature of the electrode substrate 212 during the cool operation. In some variations, the D-C controller 209 is configured to communicate with the vacuum controller 220 and the IDC controller 230 to provide commands on operating respective devices.

The D-C controller 209, IDC controller 230, and the vacuum controller 220 may collectively form a control system for the vacuum-induction heating system 200. While the D-C controller 209, IDC controller 230, and the vacuum controller 220 are described as performing specific functions, controllers 209, 230, and 220 may be configured in various suitable ways to collectively perform the functions described herein. In a non-limiting example, the vacuum controller 220 is described as monitoring and adjusting the pressure in the chamber 210 based on data from the pressure sensor 222, however, the D-C controller 209 may receive data from the pressure sensor 222 to monitor the pressure, and then transmit commands to the vacuum controller 220 to adjust operation settings of the vacuum pump 214.

In one form, the D-C controller 209 is configured to store a dry operation software application 240 (i.e., dry operation app.) to perform the dry operation and a cool operation software application 242 (i.e., cool operation app.) to perform the cool operation. Referring to FIG. 5, an example dry-cool routine 500 is provided and includes a dry operation 502 and a cool operation 504.

With the electrode substrate 212 in the chamber 210 having the coil 224, at step 506, the D-C controller 209 is configured to turn on the induction heater. That is, the D-C controller 209 activates the IDC system 206 to heat the electrode substrate 212 to a desired thermal profile by having the power source 226 provide power to the coil 224. The IDC system 206 may be activated in various suitable ways to perform the dry operation. In a non-limiting example, the D-C controller 209 may provide a desired power setpoint for the power source 226 to the IDC controller 230, which in return controls the power source 226 to apply power to the coil 224 based on the desired power setpoint. In another example, the D-C controller 209 transmits a command to the IDC controller 209 to perform an induction dry operation that may be preprogrammed in the IDC controller 209, and includes preset power setpoints for the power source 226.

At step 508, the D-C controller 209 obtains a thermal profile of the electrode substrate 212. For example, referring to FIG. 2, one or more temperature sensors 244 are provided to monitor a temperature of the electrode substrate 212. The temperature sensors may include a thermal imaging camera. The electrode substrate 212 is heated to have a desired thermal profile (i.e., a homogenous temperature).

Once the desired thermal profile is obtained, the electrode substrate 212 may be controlled at the desired thermal profile for a selected period of time or, alternatively, the D-C controller 209 proceeds to step 510 to remove particles from the chamber 210. Specifically, the D-C controller 209, activates the vacuum system 204 to create a low pressure in the chamber 210 and suck air/particles from the chamber 210. In a non-limiting example, the D-C controller 209 may transmit a command to the vacuum controller 220 to begin an evacuation process, which may be preprogrammed in the vacuum controller 220 and include preset parameters such as, but not limited to, desired pressure level in the chamber 210.

During step 510, the D-C controller 209 may turn-off power to the coil 224 to stop the electromagnetic field, stop circulating coolant in the coil 224, or both powering off the coil 224 and stopping circulation. That is, based on characteristics of the vacuum-induction heating system 200, which can be assessed during setup or testing, IDC system 206 may be deactivated and/or at least a portion of the IDC system 206 may be active when the particles are being removed. For example, if additional moisture can be removed via induction heating, the IDC system 206 may remain active. In another example, if the induction heating is beneficial during a portion of the particle removal step, power is provided to the coil 224. In yet another example, if a reduced power setpoint is provided to the coil 224, the coolant supply 228 may be turned off. While specific examples are provided, the IDC system 206 may be operated in various suitable ways during step 510, and should not be limited to the examples provided herein.

The completion of the evacuation of the particles may be determined in various suitable ways. In a non-limiting example, the evacuation may be performed for a predefined time period at one or more pressures setpoints, where the predefined time period is determined using computational models and/or experimentation. In yet another example, a sensor, which detects particles in the air, is provided at a downstream treatment area, and if particles are not detected for a period of time, the evacuation system is considered complete.

Once complete, the vacuum system 204 is deactivated, and the electrode substrate 212 is cooled during the cool operation 504. By using induction, the electrode substrate 212 is the primary if not only component that is hot (i.e., at or close to the desired thermal profile). If the coil 224 is still receiving power, the D-C controller 209 turns-off power to the coil 224 at step 512 by, in one example, requesting the IDC controller 230 to turn-off power to the coil 224. Step 512 may be removed if the coil 224 is already off at the end of step 510.

In one form, the D-C controller 209 performs the cool operation by injecting the chamber 210 with a cooling agent (e.g., nitrogen gas), at step 514, and circulates coolant through the coil 224, at step 516. That is, at 514 the D-C controller 209 has the cooling system 208 inject the cooling gas into the chamber 210, which may be provided during at least a portion of the cool operation.

At step 516, the coil 224 of the IDC system 206, which is close to the electrode substate 212, operates as a heat changer to cool the electrode substrate 212 by having the coolant absorb heat from electrode substrate 212. From the coil 224, the heated coolant is cooled to a desired temperature before being recirculated through the coil 224. The D-C controller 209 monitors the temperature of the electrode substrate 212, and once it reaches a desired cooled setpoint, the cooling system 208 is controlled to stop injecting the cooling gas and the coolant is no longer circulating in the coil 224. From the chamber 210, the electrode substrate 212 is transferred to a cell assembly process.

It should be readily understood that the dry-cool routine 500 may be configured in various suitable ways, and should not be limited to the routine provided herein. For example, step 514 for injecting the cooling agent may be removed. In another example, coolant may not be circulated in the coil 224 as part of the cool operation (i.e., step 516 is removed). In yet another example, the coolant may be circulated during at least a portion of the cool operation.

The vacuum-induction heating system 200 of the present disclosure allows for efficient transference of energy to the electrode substrate 212 in vacuum in order to increase the temperature of the substrate 212 without physical contact. The system 200 provides for more even distribution of heat through the substrate 212 and can be strategically geared to allow only the components within the substrate to be heated. For example, the carbon used in battery electrodes are typically microporous and traps most of the residual moisture that then requires vacuum drying. The induction heating process can be tailored to heat specifically the carbon in the electrode to increase the rate of releasing the moisture stuck within the pores of the carbon particles and without applying direct heat to the polymer binder that is also in the electrode structure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A system for a battery manufacturing process, comprising:
a housing defining a chamber adapted to receive an electrode substrate;
a vacuum system fluidly coupled to the housing and operable to remove particles in the chamber via suction;
an induction dry-cool system including one or more coils provided in the chamber, wherein the one or more coils are operable to heat the electrode substrate via induction during a dry operation and to reduce temperature of the electrode substrate during a cooling operation; and
a control system configured to control the vacuum system and the induction dry-cool system during the dry operation and the cooling operation.

2. The system of claim 1, wherein, for the dry operation, the control system is configured to:
control power to the one or more coils until a desired thermal profile is obtained for the electrode substrate, and
activate the vacuum system to induce suction in the chamber.

3. The system of claim 2, wherein:
the one or more coils define an internal fluid path; and
during at least a portion of the dry operation, the control system is configured to circulate coolant through the internal fluid path to control a temperature of the one or more coils.

4. The system of claim 1, wherein:
the one or more coils define an internal fluid path,
for the cooling operation, the control system is configured to stop power to the one or more coils, and
during at least a portion of the cooling operation, the control system is configured to circulate coolant through the internal fluid path.

5. The system of claim 1, wherein the one or more coils are adapted to be in a non-contact proximity to the electrode substrate to induce current at the electrode substrate during the dry operation.

6. The system of claim 1, wherein:
the one or more coils defines an internal fluid path,
during at least a portion of the dry operation, the control system is configured to circulate coolant through the internal fluid path to control temperature of the one or more coils,
for the cooling operation, the control system is configured to stop power to the one or more coils, and
during at least a portion of the cooling operation, the control system is configured to circulate coolant through the internal fluid path to reduce the temperature of the electrode substrate.

7. The system of claim 1, further comprising:
a cooling system fluidly coupled to the housing to inject a cooling agent into the chamber,
wherein the control system is configured to control the cooling system to inject the cooling agent into the chamber during the cooling operation.

8. The system of claim 7, wherein the cooling agent is nitrogen.

9. A system for a battery manufacturing process, comprising:
a housing defining a chamber adapted to receive an electrode substrate;
a vacuum system fluidly coupled to the housing and operable to remove particles in the chamber via suction;
an induction dry-cool system including one or more coils provided in the chamber, wherein the one or more coils are operable to heat the electrode substrate via induction during a dry operation; and
a control system configured to, during the dry operation, control power to the one or more coils until a desired thermal profile is obtained for the electrode substrate, and activate the vacuum system to induce suction in the chamber to remove air from the chamber.

10. The system of claim 9, wherein:
the one or more coils define an internal fluid path; and
during at least a portion of the dry operation, the control system is configured to circulate coolant through the internal fluid path to control temperature of the one or more coils.

11. The system of claim 9, wherein the one or more coils are adapted to be in a non-contact proximity to the electrode substrate to induce current at the electrode substrate during the dry operation.

12. The system of claim 9, wherein the control system is configured to control the vacuum system and the induction dry-cool system during a cooling operation to reduce a temperature of the electrode substrate.

13. The system of claim 12, wherein:
the one or more coils defines an internal fluid path,
during at least a portion of the dry operation, the control system is configured to circulate coolant through the internal fluid path to control a temperature of the one or more coils,
for the cooling operation, the control system is configured to stop power to the one or more coils, and
during at least a portion of the cooling operation, the control system is configured to circulate coolant through the internal fluid path.

14. The system of claim 12, further comprising:
a cooling system fluidly coupled to the housing to inject a cooling agent into the chamber,
wherein the control system is configured to control the cooling system to inject the cooling agent into the chamber during at least a portion of the cooling operation.

15. The system of claim 14, wherein the cooling agent is nitrogen.

16. A system for a battery manufacturing process, comprising:
a vacuum system fluidly coupled to a housing defining a chamber adapted to receive an electrode substrate, and operable to remove particles in the chamber via suction;
an induction dry-cool system including one or more coils provided in the chamber, defining an internal fluid path, and operable to heat the electrode substrate via induction during a dry operation and to reduce temperature of the electrode substrate during a subsequent cooling operation; and
a control system configured to,
during the dry operation, control power to the one or more coils until a desired thermal profile is obtained for the electrode substrate, and activate the vacuum system to induce suction in the chamber to remove air from the chamber, and
during the cooling operation, stop power to the one or more coils, and circulate coolant through the internal fluid path.

17. The system of claim 16, further comprising:
a cooling system fluidly coupled to the housing to inject a cooling agent into the chamber,
wherein the control system is configured to control the cooling system to inject the cooling agent into the chamber for at least some of the cooling operation.

18. The system of claim 17, wherein the cooling agent is nitrogen.

19. The system of claim 16, wherein during at least a portion of the dry operation, the control system is configured to circulate coolant through the internal fluid path to control temperature of the one or more coils.

20. The system of claim 16, wherein the one or more coils are adapted to be in a non-contact proximity to the electrode substrate to induce current at the electrode substrate during the dry operation.
